(19) United States
(12) Patent Application Publication
(10) Pub. No.: US 2002/0183984 A1
(43) Pub. Date: Dec. 5, 2002

(54) Modular intelligent multimedia analysis system

(76) Inventors: Yining Deng, Mountain View, CA (US); Jelena Tesic, Goleta, CA (US)

Correspondence Address: HEWLETT-PACKARD COMPANY, Intellectual Property Admiinistration, P.O. Box 272400, Fort Collins, CO, 80527-2400, US

(21) Appl. No.: 09/875,434

(22) Filed: Jun. 5, 2001

(51) Int. Cl. G06F 17/50; G06F 7/60; G06F 17/10

(52) U.S. Cl. 703/1

(57) ABSTRACT

A system and method for categorizing non-textual subject data, such as digital images, utilizes content-based data and meta-data to determine outcomes of classification tasks. The classification system has a modular architecture in which modules configured to perform specific functions, including algorithmic functions, can be integrated or deleted from the system. At the center of the classification system is a decision module comprising: (1) a task component having a number of classification tasks arranged within a task tree configuration, (2) an algorithmic component for selecting an algorithm for each classification task, (3) a sub-algorithmic component for selecting sub-algorithmic routines for each algorithm, and (4) a learning component for constructing and modifying the arrangement of the task tree and the classification tasks based on the frequencies of occurrences for the classes associated with a set of files.

### TECHNICAL FIELD

The invention relates generally to classifying non-textual subject data and more particularly to a system and method for categorizing subject data with class labels.

### BACKGROUND ART

With the proliferation of imaging technology in consumer applications (e.g., digital cameras and Internet-based support), it is becoming more common to store digitized photo-albums and other multimedia contents, such as video files, in personal computers (PCs). There are several known approaches to categorizing multimedia contents. One approach is to organize the contents (e.g., images) in a chronological order from the earlier events to the most recent events. Another approach is to organize the contents by a topic of interest, such as a vacation or a favorite pet. Assuming that the contents to be categorized are relatively few in number, utilizing either of the two approaches is practical, since the volume can easily be managed.

In a less conventional approach, categorization is performed using enabling technology which analyzes the content of the multimedia to be organized. This approach can be useful for businesses and corporations, where the volume of contents, including images to be categorized, can be tremendously large. A typical means for categorizing images utilizing content-analysis technology is to identify the data with class labels (i.e., semantic descriptions) that describe the attributes of the image. A proper classification allows search software to effectively search for the image by matching a query with the identified class labels. As an example, a classification for an image of a sunset along a sandy beach of Hawaii may include the class labels sunset, beach and Hawaii. Following the classification, any one of these descriptions may be input as a query during a search operation.

A substantial amount of research effort has been expended in content-based processing to provide a better categorization for digital image, video and audio files. In content-based processing, an algorithm or a set of algorithms is implemented to analyze the content of the files, so that the appropriate identifying class(es) can be associated with the files. Content similarity, color variance comparison, and contrast analysis may be performed. For color variance analysis, a block-based color histogram correlation method may be performed between consecutive images to determine color similarity of images at the event boundaries. Other types of content-based processing allow a determination of an indoor/outdoor classification, city/landscape classification, sunset/mid-day classification, face detection classification, and the like.

Unfortunately, many content-based algorithms are not adequate for classifying photo-quality images having a large variety of image attributes. Moreover, many research groups do not possess adequate resources to build a complete system that can classify most of the image categories corresponding to respective attributes. Rather, they can only build a system focusing on a few classifying methods focusing only on a few attributes. For example, while many visual feature descriptors are being standardized in MPEG-7, including color, texture, shape, motion, and the like, only a few descriptors are being utilized in content-based processing.

What is needed is a file-categorization system and method which provide a high level of reliability with regard to assignments of file classes.

### SUMMARY OF THE INVENTION

The invention is a system and method for categorizing non-textual subject data on the basis of descriptive class labels (i.e., semantic descriptions or “descriptors”). The system has system modules and non-system modules in which new modules that provide more effective classifying functions can be integrated into the system and existing modules that provide less effective classifying functions can be deleted from the system. At the center of the classification system is a system decision module comprising: (1) a task component which performs a number of classification tasks arranged in a sequential progression of decision-making, (2) an algorithmic component for selecting an algorithm for each classification task, (3) a sub-algorithmic component for selecting sub-algorithmic routines for each algorithm, and (4) a learning component for modifying the arrangement of the classification tasks based on the frequencies of assignments of the classes within a set of data files.

The classification system also includes a system web-service module, system interface module, and system input/output module, all of which are primarily utilized for communication purposes. Additionally, the classification system includes a number of interchangeable non-system modules. Each non-system module comprises a sub-algorithmic routine for performing a mathematical function for a classification task.

The classification scheme begins with a capture of non-textual subject data by a recording device. In a preferred embodiment in which the device is a digital camera, a digital image file is captured and meta-data that is specific to the situationally surrounding conditions (e.g., time and date) of the recording device during the capture of the non-textual subject data is recorded. The image file is categorized on the basis of selected classes by subjecting the image to a series of classification tasks in a sequential progression of decision-making within a task tree arrangement. The order for the progression is determined by the task component of the system decision module. The class labels that are selected as the descriptions of a particular image are utilized for organization and for matching a query when a search for the image is subsequently conducted.

The classification tasks are nodes within the task tree that invoke algorithms for determining whether classes should be assigned to images. Utilizing content-based analysis, meta-data analysis, or a combination of the two, the image is subjected to a classification task at each node of the task tree for determining whether a particular class can be identified with the image. Each classification task includes an algorithm selected from the algorithmic component. In one aspect of the invention, there are classification tasks that have alternative algorithms in which a selection from among alternative algorithms is based upon prior determinations at previous nodes within the task tree. For example, there may be alternative face detection algorithms for determining whether an image includes facial features. If it has already been determined that the image is an outdoor scene, the face detection algorithm that is best suited for detecting facial features within an outdoor scene is selected.

The algorithm corresponding to each classification task comprises a number of sub-algorithmic routines. Each sub-algorithmic routine is stored within a non-system module. The selection of which sub-algorithmic routine to execute is determined by the sub-algorithmic component of the system decision module. Identifying a class for a particular classification task includes: (1) subjecting the image to a transformation sub-algorithmic routine into a suitable data space for subsequent analysis, (2) performing a feature operator sub-algorithmic routine to derive feature operator data, such as deducing values corresponding to a background color of the subject image, and (3) classifying the featured data, utilizing classification sub-algorithmic routines, such as Bayesian analysis, neural network analysis, Hidden Markov Model (HMM), and the like.

The sub-algorithmic routines are executed through a control component of the system interface module. Intermediate results of sub-algorithmic routines for possible use at a subsequent node as well as the identified class are stored in a data component of the system interface module.

The sequential progression of decision making is established by the learning component of the system decision module. The learning component gathers instructions and feedback to construct rules for the other three components (i.e., task component, algorithmic component and sub-algorithmic component), including utilizing an association pattern technique found in data mining during both on-line implementation and off-line training.

One of the advantages of the classification system is that newer modules with more effective classification functions can be integrated into the classification system if any existing function becomes obsolete, so that the system does not need to be discarded. Additionally, by providing a modular architecture and connectivity among system and non-system modules, the system can be implemented in different locales.

### BRIEF DESCRIPTION OF THE DRAWINGS

FIG. 1 is a block diagram of a classification system including a recording device for capturing non-textual subject data and recording meta-data, and a modular intelligent multimedia analysis system (MIMAS) for classifying the subject data in accordance with the invention.

FIG. 2 is a schematic view of the MIMAS of FIG. 1 having a modular architecture comprising system modules and non-system modules.

FIG. 3 is a schematic view of a task tree of the task component utilized for the sequential progression of decision making.

FIG. 4 is an illustration of an algorithmic look-up table for a set of algorithms that are specific to face detection.

FIG. 5 is an illustration of a sub-algorithmic look-up table having storage modules for storing intermediate results and values corresponding to classification tasks.

FIG. 6 is a process flow diagram for identifying a class for a classification task.

FIG. 7 is a block diagram of a learning component for creating a sequential progression of decision making from a set of training images.

FIG. 8 is an illustration of a training image table having a set of training images of FIG. 7 and corresponding classes that are specific to each image.

FIG. 9 is an illustration of a frequency distribution table having a frequency distribution of all the classes that are associated with the set of training images of FIG. 7.

FIG. 10 is an illustration of a resulting order table showing the order of the classification tasks for the training images of FIG. 7.

FIG. 11 is an illustration of a partial table showing the order of the classification tasks.

FIG. 12 is a schematic view of a task tree having a sequential progression of decision making.

FIG. 13 is a process flow diagram for categorizing non-textual data.

### DETAILED DESCRIPTION

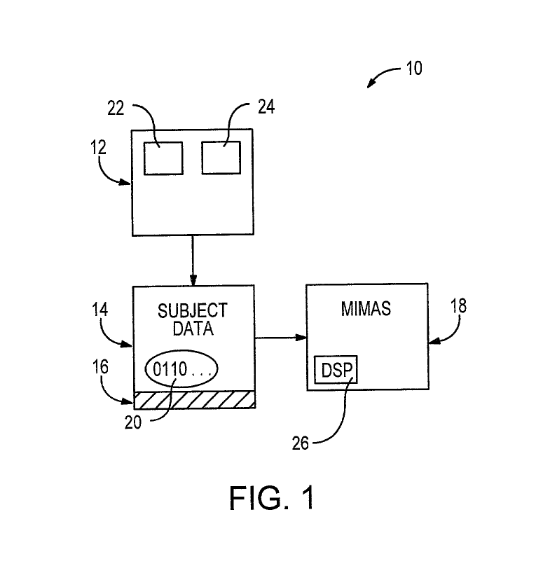

With reference to FIG. 1, a classification system 10 includes at least one recording device 12 for capturing both a file of non-textual subject data 14 and a tagline of associated meta-data 16. The subject data and the meta-data are transferred to a Modular Intelligent Multimedia Analysis System (MIMAS) 18 for identifying class labels (i.e., semantic descriptions) associated with the non-textual subject data. In one embodiment, the non-textual subject data is a digitized image file 20 that is captured by a digital camera 22. Alternatively, the subject data is a video file captured by a video recorder 24.

The files are segmented into blocks of data for analysis using means (algorithms) known in the art. Along with each file of non-textual subject data 14, meta-data that is specific to the situationally surrounding conditions (e.g., time and date) of the recording device 12 during the capture of the non-textual subject data is recorded. Classification by the MIMAS 18 includes applying digital signal processing (DSP) 26 to the non-textual subject data and includes considering the meta-data.

While the preferred embodiment identifies the non-textual subject data 14 as a digitized image, other forms of captured data, including non-textual analog-based data from an analog recording device, can be classified using the techniques to be described in detail below. By means known in the art, the analog-based data is digitized prior to processing. Meta-data that is specific to situationally surrounding conditions of the analog recording device during the capture of the subject data can be recorded and entered manually by an operator.

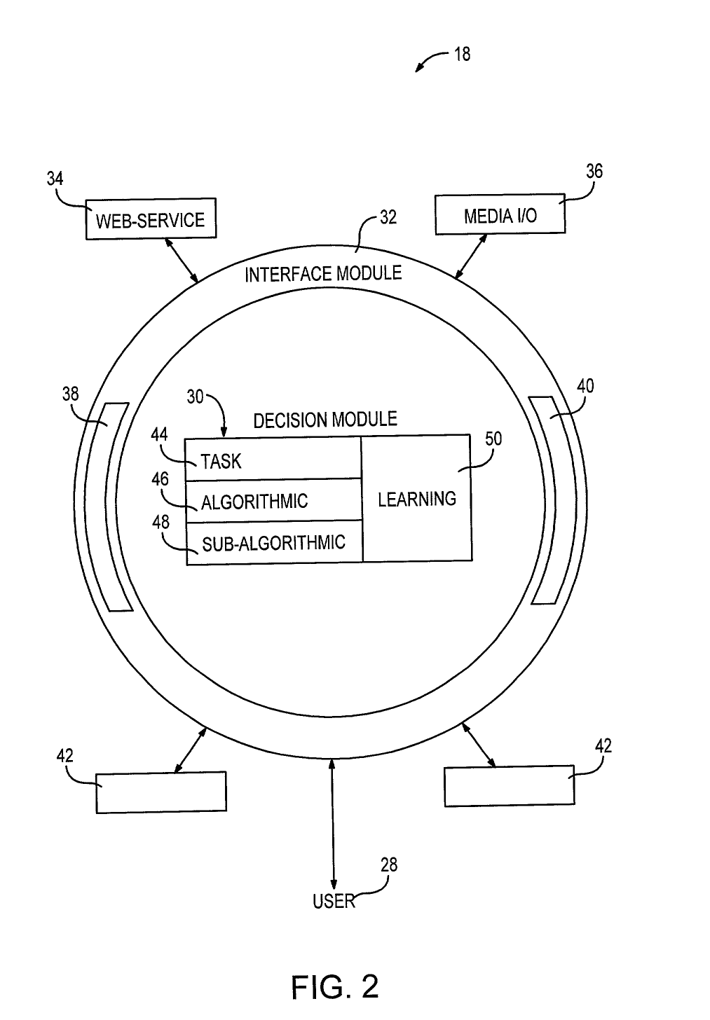

FIG. 2 shows the MIMAS 18 that is configured to accept a classification request (e.g., subject image) from a user 28 and to analyze the request prior to sending back the results (i.e., class labels) to the user. The MIMAS has a modular architecture comprising system modules and non-system modules in which new modules having more efficient classifying functions can be integrated into the MIMAS and existing modules having less efficient classifying functions can be deleted from the MIMAS. The system modules include a decision module 30, interface module 32, web-service module 34 and a media input/output module 36. Since the system decision module 30 is the primary component of the MIMAS, the modules 32, 34 and 36 having secondary functions will be discussed first.

The system interface module 32 enables communications and the transmissions of data among all the modules. The system interface module includes a data component 38 and a control component 40. The data component 38 provides storage and memory management for the subject data, for the intermediate results of the sub-algorithmic routines, and for the identified classes. The control component 40 locates a non-system module 42 on which a particular sub-algorithmic routine resides, directs and executes the sub-algorithmic routine, and returns the value associated with the sub-algorithmic routine back to the decision module 30.

The system web-service module 34 provides a front-end user interface to the MIMAS 18 by accepting classification requests from end-users through the Internet and analyzing the data prior to sending the results back to the users. The web-service module provides a back-end interface for developers to add new modules to the MIMAS. The system media input/output module 36 administers file input/output by reading and writing data among the modules.

The MIMAS 18 also includes a number of interchangeable non-system modules 42. Each non-system module includes a sub-algorithmic routine in a classification algorithm.

At the center of the MIMAS 18 is the system decision module 30 comprising: (1) a task component 44 which performs a number of classification tasks arranged in a sequential progression of decision-making, (2) an algorithmic component 46 for selecting an algorithm for each classification task, (3) a sub-algorithmic component 48 for selecting sub-algorithmic routines for each algorithm, and (4) a learning component 50 for constructing and modifying the arrangement of the classification tasks, algorithms and sub-algorithmic routines based on the frequencies of assignments of the classes within a set of data file.

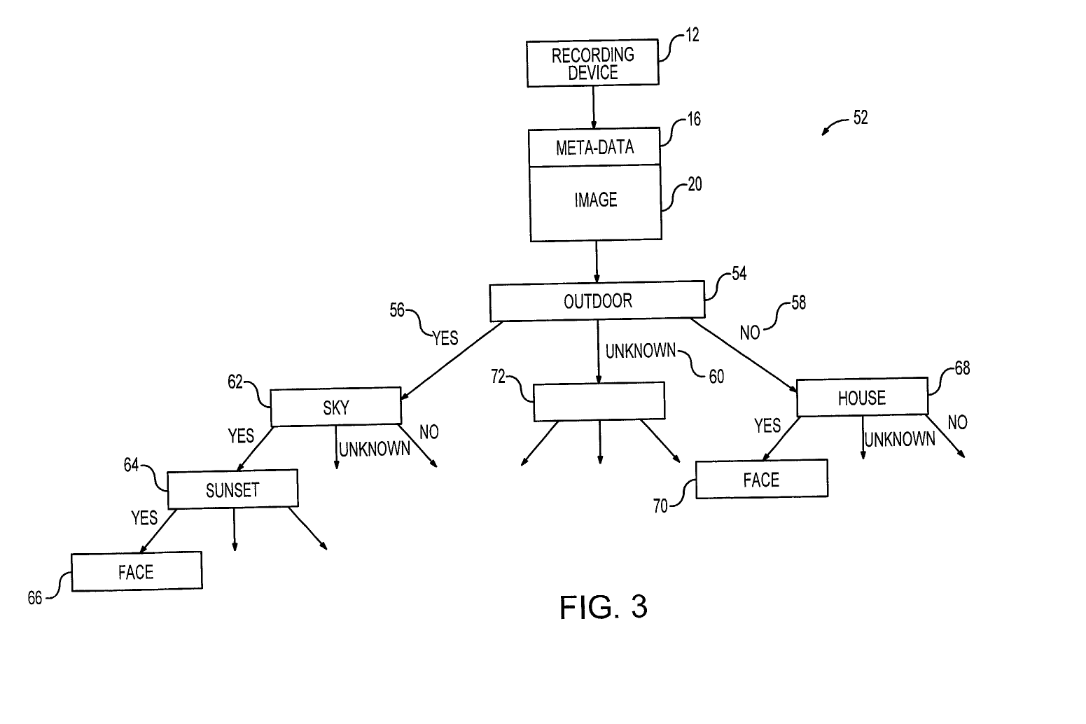

With reference to FIG. 3, the classification scheme begins with the capture of the non-textual subject data. In the embodiment in which the recording device 12 is the digital camera 22, the digitized image file 20 is captured along with associated meta-data 16. Utilizing content-based data, meta-data, or a combination of the two, the data is subjected to classification as determined by operations within a task tree 52. Each classification task includes an algorithm selected from the algorithmic component 46 of the system decision module 30 of FIG. 2.

Referring to the task tree 52 of FIG. 3, the image 20 and the attached meta-data 16 are subjected to an outdoor classification task 54 in the first order to determine if the image is characteristic of an outdoor scene or indoor scene. Each classification task corresponds to a task node, with each task having three possible outcomes or states of nature (i.e., yes 56, no 58, or unknown 60). However, the tasks may be limited to selecting between only two outcomes or may have more than three possible outcomes. If the outcome of a decision node is a yes, two events follow. First, the image is identified with a particular value. In the case of node 54, the value corresponds to an outdoor class. Second, the image is directed to a next classification task which, in this case, is a sky classification task 62. Task 62 determines whether the image can be identified with a sky class in addition to the already identified outdoor class. If the image is determined by the sky classification task 62 to include a sky, a sunset classification task 64 follows. If the image 20 includes a sunset, a face detection classification task 66 follows. The classification scheme continues until the “bottom” of the task tree 52 is reached.

An image subjected to analysis may be identified with multiple classes. In the task tree 52, the subject image 20 may be identified with an outdoor class, a sky class, a sunset class, and a face class. The number of possible classes is dependent on the progressive nature of the classification scheme of the task tree.

Returning to the outdoor classification task 54, if the outcome is a no 58, the image 20 is not identified with an outdoor class. Subsequently, the image progresses to a next classification task which, in this case, is a house classification task 68 to determine whether the image includes a house. If the outcome of the house classification task 68 is a yes, the image is identified with a house class. Moreover, a face detection classification task 70 follows to detect whether the image 20 also includes a face.

Again returning to the outdoor classification task 54, if the algorithm outcome is determined to be the unknown 60 (i.e., analysis of the task 54 is unable to determine whether the image 20 was taken indoors or outdoors), the categorization of the image 20 is directed to a third possible classification task 72. This task may be a default (e.g., applying an algorithm dedicated to determining whether an image is of an indoor environment) or may be a decision node that is neutral with respect to the environment.

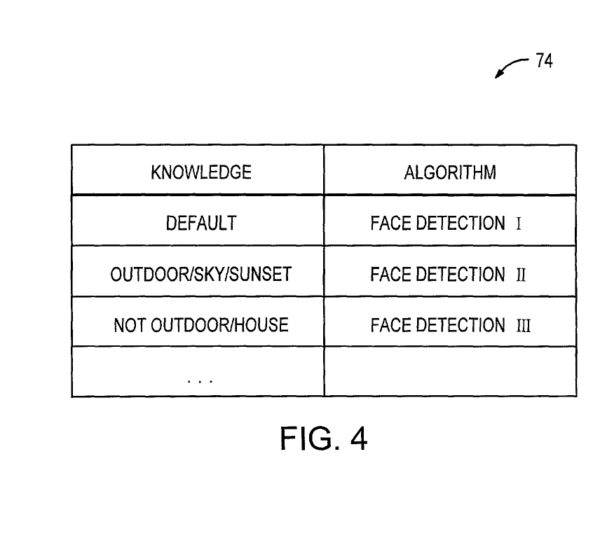

In the implementation of tree 52 of FIG. 3, the algorithmic component 46 of FIG. 2 selects which algorithm to perform for a given classification task (i.e., task node) and performs the algorithmic processing for the task. More than one algorithm may be available at a single task node. The algorithm component makes the selections based on factors such as knowledge of previous outcomes. Thus, one face detection algorithm may be utilized for one camera type, a different face detection algorithm may be utilized if another camera type was used in generating the subject image, and a default face detection algorithm may be utilized if there is no a priori information regarding camera type. Similarly, a first face detection algorithm may be used if it is determined that the image is of an outdoor scene, while a second face detection algorithm may be used for indoor scenes. As will be explained with reference to FIG. 4, an algorithmic look-up table 74 may be used in storing the knowledge requirements for each algorithm.

The algorithmic look-up table 74 indicates a set of algorithms that are specific to face detection. Each algorithm is distinct and may be dependent on a priori knowledge obtained during propagation through the task tree 52 of FIG. 3. For example, a face detection II algorithm is identified as being best suited for the face detection classification task 66, since the image includes a sunset. Face detection III algorithm is best suited for the face detection classification task 70, since the image includes the interior of a house. Finally, face detection I algorithm is a default algorithm that is implemented at a face detection classification task that is the first classification task in the first order without any a priori knowledge of which classifier was previously designated. The algorithmic look-up table can be updated manually or by the learning component 50 of FIG. 2, which gathers the performance information of each task node in the tree structure.

The algorithm corresponding to each classification task comprises a number of sub-algorithmic routines. Each sub-algorithmic routine is stored within the non-system module 42 of FIG. 2. The selection of which sub-algorithmic routine to implement is determined by the sub-algorithmic component 48 of the system decision module 30. For example, the face detection II algorithm of FIG. 4 that is applicable to detecting an image with an outdoor scene having a sunset comprises multiple sub-algorithmic routines, including data transformation, feature operator and classification. One of these sub-routines may be a component of another algorithm or the algorithm that is utilized in a subsequent task.

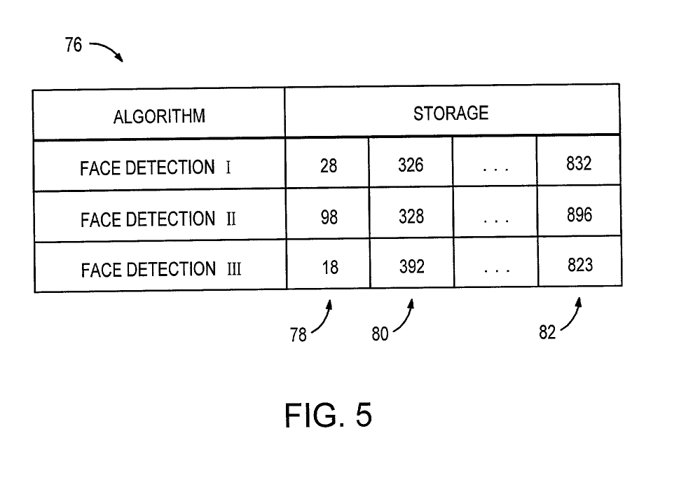

In addition to the designations of sub-routines, the sub-algorithmic component stores the results of the sub-algorithmic routines in the data component 38 of FIG. 2. That is, the sub-algorithmic component stores intermediate results that can be reused at a later time, if the same operation is again performed. FIG. 5 shows a sub-algorithmic look-up table 76 having storage for storing intermediate results for data transformation sub-algorithmic routines 78, feature operator sub-algorithmic routines 80, and values corresponding to a hypothetical classification sub-algorithmic routine 82. The results are stored automatically, without assurance that they will be needed at a later time.

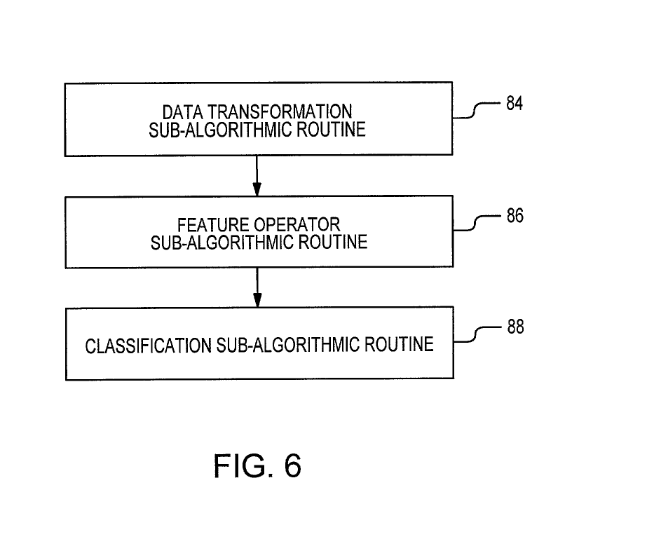

FIG. 6 shows a process flow diagram for identifying a class for a classification task. That is, in implementing an algorithm for a classification task, a series of steps or sub-algorithmic routines is taken for identifying a class. In step 84, the image 20 is subjected to a data transformation sub-algorithmic routine in which image data or the outputs from other transformation sub-algorithmic routines is/are converted into a suitable data space in which image characteristics can more easily be explored. Typical data transformation sub-algorithmic routines include discrete cosine transform (DCT), discrete Fourier transform (DFT), wavelet transforms, color space conversions, noise filtering, region of interest, edge detection, multi-resolution approach, etc.

In step 86, the transformed data from step 84 is subjected to a feature operator sub-algorithmic routine to derive feature operator data for determining characteristics unique to the image 20. Content similarity, color variance comparison, and contrast analysis may be performed. Many of these sub-algorithmic routines exploit the statistical distribution of the data, such as histogram, moments, means and threshold values. Pixel data rearranged in image blocks can be used directly as feature vectors. As an example, a block-based color histogram correlation sub-routine may be performed between consecutive images to determine color similarity of images at the event boundaries for color variance analysis of an image sequence.

In step 88, the feature data from step 86 is classified utilizing classification sub-algorithmic routines, such as Bayesian analysis, neural network analysis, Hidden Markov Model (HMM), maximum likelihood (ML), genetic algorithm, support vector machine (SVM) and multidimensional scaling, to generate a class identifiable with the subject image 20.

Returning to FIG. 2, the learning component 50 of the system decision module 30 of FIG. 2 gathers instructions and feedback to construct rules for the other three components (i.e., task component 44, algorithmic component 46 and sub-algorithmic component 48) of the system decision module 30. In addition to off-line training, the learning component is active during periods of actual use (i.e., beyond the processing to initially configure the task tree). The learning component supervises and modifies the classification tasks of the task tree based on system performance and feedback from the other three components 44, 46 and 48. The learning component keeps count of the frequencies of assignments of the classes for the incoming subject images. If there is a significant change in the frequencies of occurrences for the identified classes, the learning component modifies and updates the hierarchical structure of the task tree accordingly. Moreover, if there is a classification task that receives a negative feedback (i.e., an outcome that is a no) at a decision node, the learning component stores the negative feedback and may eventually incorporate a change in the tree structure.

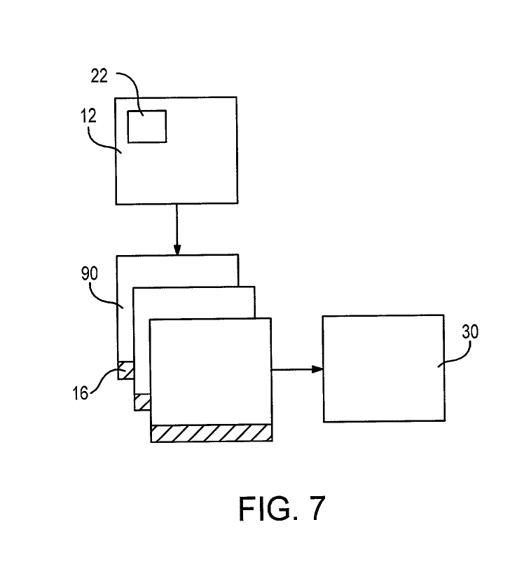

For the task component 44 of FIG. 2, the construction of a task tree by the learning component 50 for determining the sequential progression of decision making is initially created from a set of training images 90, as represented in FIG. 7. The rules regarding the task tree and the paths leading from one classification task to the next are constructed using association pattern techniques. During the learning phase, the recording device 12 (e.g., digital camera 22) can be used for capturing the set of training images 90 and recording the meta-data 16.

The set of training images 90 is used to order the classification tasks into a sequential progression based on at least one of the following three methods: (1) content-based analysis, (2) meta-data analysis, and (3) designation of at least one class by an external unit or human operator. Each training image is identified with at least one class, depending on the content of the image and/or the meta-data associated with the operational conditions of the recording device 12 during the capture of the image.

While the set of training images 90 of FIG. 7 shows only a limited number of training images, there should be a much larger number of training images for creating the sequential progression of decision making within the task tree. Moreover, the set should include images with varying contents and meta-data.

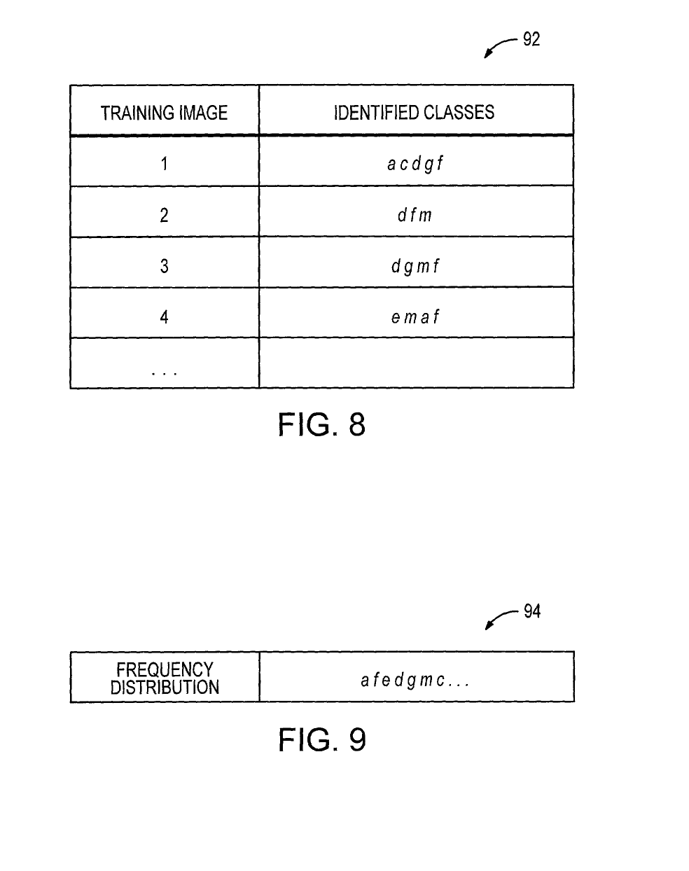

FIG. 8 shows a training image table 92 having a set of training images 1, 2, 3, 4, . . . and corresponding classes. In this example, training image 1 includes classes: acdgf. The classes are in no particular order, since the calculations of statistical probability of class occurrences have not been made at this point in the learning process. As an example, the class a may represent outdoor, c may represent sand, d may represent hands, g may represent beach, and f may represent face.

The order of sequential progression for the task tree is determined by utilizing frequency distribution for the various classes that are associated with the set of training images 90. Referring to FIG. 9, a frequency distribution table 94 reflects a frequency count for all the classes that are associated with the set of training images. The order of occurrence is: afedgmc . . . The frequency distribution is derived by ranking each class from the highest count of occurrences to the lowest count of occurrences. In the exemplary embodiment, the class a has the highest count, since it appeared most often within the set of training images. Following the class a is the class f. The ranking continues until the position of the last class is determined.

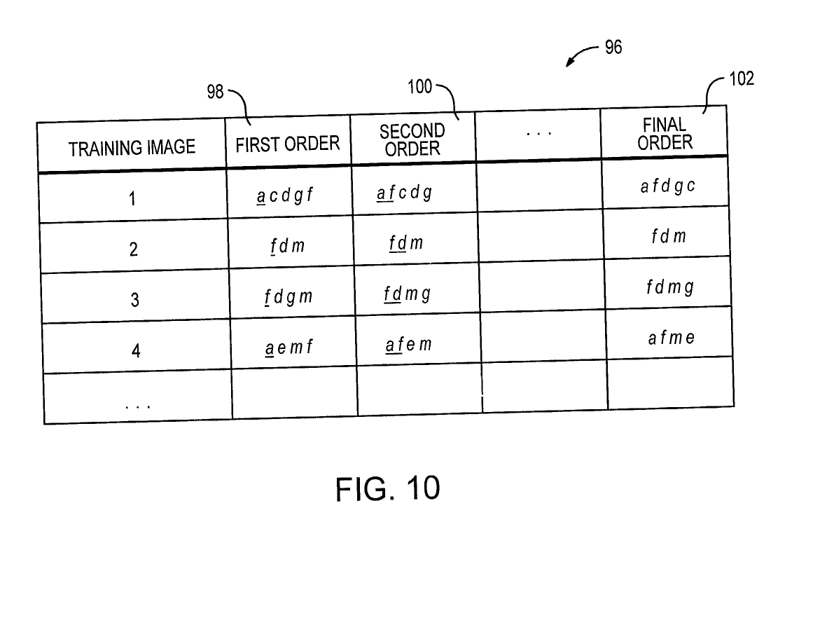

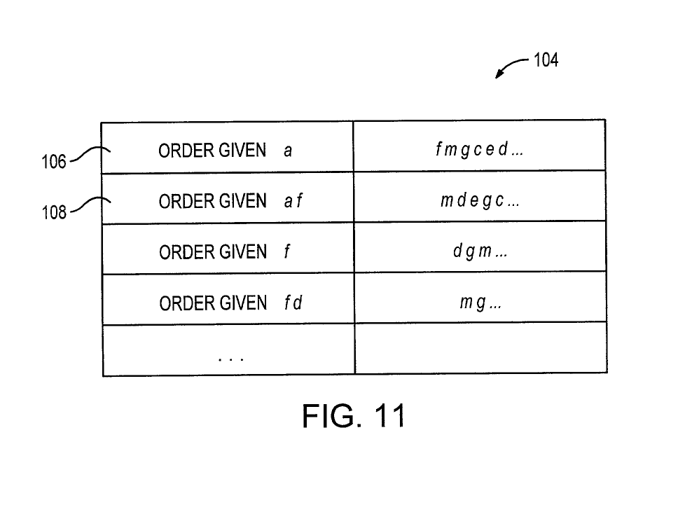

A next step in the learning process for forming the task tree is to rank the classes for each of the training images in the set. That is, for each training image 1, 2, 3, 4, . . . in FIG. 8, the classes identified for that image are placed in an order. The order of the listed identifiers of an image is based upon the statistical probability of the existence of a particular listed class given the existence of more frequently encountered classes. That is, conditional probabilities are calculated, where the conditions involve the presence or absence of other classes. An example of a resulting order table 96 is shown in FIG. 10. In a “First Order” column 98, the first class in the order is identified for each training image. The identified first order class is underlined in column 98. The process for selecting the first order class may merely be a reference to the frequency count in the table 94 of FIG. 9. Thus, class a will be the first order class for each image that includes the feature represented by class a. On the other hand, if a particular image does not include the image feature of class a, the first order class will be class f, if the image includes the corresponding feature. In the example, training images 1 and 4 have class a as their first order classes, while the training images 2 and 3 have the class f as their first order classes. The remaining class of each list in column 98 are in no particular order.

In column 100, the second order classes are calculated on the basis of conditional probabilities. Again, frequency pattern techniques may be employed. For each of the training images 1, 2, 3, 4, . . . , given the first order class of that image, the second order class is the one which has the greatest statistical probability of being listed. In the “Second Order” column 100, the first and second order classes are shown as being underlined, while the remaining classes have no particular order.

Third order classes are those classes in a list that have the greatest statistical probability of being present, given the presence of the first and second order classes. The process continues until all of the classes in each list are ordered on the basis of conditional probabilities. In FIG. 10, the final orders are shown in column 102.

FIG. 11 shows a partial table 104 of conditional probabilities. In row 106, the frequency pattern for images that include the feature associated with class a are listed to reflect the frequency pattern that was detected for the set of training images. Row 108 shows the frequency pattern for images that include the classes a and f. The different rows are determined in the same manner as the frequency distribution table 94 of FIG. 9. Some inconsistencies in the ordering may appear, but the inconsistencies are explainable.

For example, if classes a, f and d respectively correspond to the features outdoor, face and hand, it can be seen why the class d ranks more highly in the row 108 (which considers only those images taken outdoors that include a face) than in row 106 (which considers all outdoor images, regardless of whether they include a face or not).

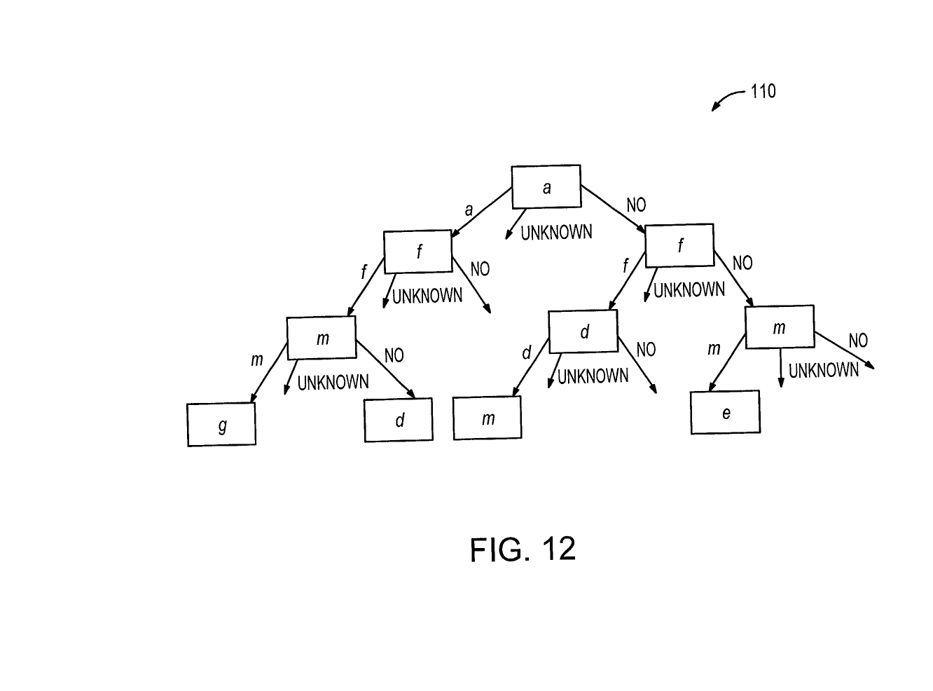

The learning that takes place in constructing the tables described with reference to FIGS. 9, 10 and 11 may be used to design an efficient task tree 110, such as the one shown in FIG. 12. The task tree begins with the most frequently encountered class a. If a is “true,” the next task is the f classification task, which is consistent with the row 106 in the table 104 of FIG. 11. On the other hand, if a is “no,” the next task is still an f classification task, but a different “f algorithm” may be used and the subsequent pattern will be different.

For the algorithmic component 46 of FIG. 2, the learning component 50 chooses the optimal algorithm for each classification task. With reference to FIG. 4 as an example, a specific face detection algorithm I, II, or III is identified as being best suited for face detection within a particular environment (i.e., default, sunset, or the interior of a house). Identification of a specific face detection algorithm corresponding to a particular environment can be made and updated manually by an operator, or by an automated learning technique which gathers the performance information for each classification task.

Additionally, the learning component 50 identifies the optimal sub-algorithmic routines for each algorithm. Identification is made in a learning step (not shown) following the data transformation sub-algorithmic routine step 84 and feature operator sub-algorithmic routine step 86 of FIG. 6, utilizing learning sub-algorithmic routines identified in the classification sub-algorithmic routine step 88. Again, identification of a sub-algorithmic routine for an algorithm can be made and updated manually by an operator, or by an automated learning technique which gathers the performance information for each algorithm.

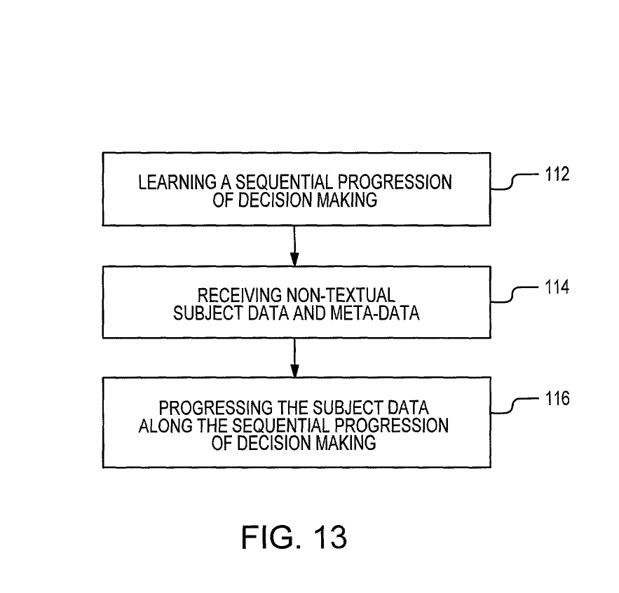

Operations of the classification system for categorizing non-textual subject data are sequentially shown in FIG. 13. In step 112, the sequential progression of decision making utilizing the task tree 110 is generated by the MIMAS 18. The task tree comprises a number of nodes, with each node being configured to perform a classification task. Each classification task determines whether a class is assigned to the subject data on the basis of content analysis and/or meta-data analysis. In step 114, the non-textual subject data and meta-data are received by the classification system for analysis. In step 116, the subject data is analyzed by progressing the data along the sequential progression of decision making, as determined by step 112.

What is claimed is:

1. A system for classifying files of non-textual subject data comprising:
a system decision module that includes:
(a) a task component having a plurality of classification tasks arranged in a sequential progression of decision making, said sequential progression of decision making including a plurality of classification nodes for assigning classes, at least some of said classification nodes including algorithms for determining which of a plurality of alternative next classification nodes is to be encountered in said sequential progression of decision making;
(b) an algorithmic component for selecting an algorithm for each of said classification tasks, said algorithm being configured to execute at least one of content-based analysis for processing content-based data and meta-data analysis for processing meta-data;
(c) a sub-algorithmic component for selecting at least one sub-algorithmic routine for said algorithm, said sub-algorithmic routine being selected based on said selecting said algorithm; and
(d) a learning component for modifying said arrangement of classification tasks according to determinations of the frequencies of assignments of said classes to said files of non-textual subject data.

2. The system of claim 1 further comprising a system web-service module for providing Internet access to said system decision module.

3. The system of claim 1 further comprising a system interface module for providing communications among a plurality of system and non-system modules, wherein one of said system modules is said system decision module.

4. The system of claim 3 wherein each of said non-system modules includes at least one said sub-algorithmic routine.

5. The system of claim 3 wherein said system interface module further includes data components for storing data associated with classifying a plurality of said files of said non-textual subject data and at least one control component for executing said sub-algorithmic routines.

6. The system of claim 1 further comprising a media input/output module for administering data associated with classifying said non-textual subject data by reading and writing said data among a plurality of modules.

7. The system of claim 1 wherein said learning component is configured to identify an algorithm for each of said classification tasks and at least one sub-algorithmic routine for said algorithm.

8. The system of claim 1 further comprising a data capturing device configured to capture said content-based data and record said meta-data, said content-based data corresponding to content information of a file of said subject data and said meta-data corresponding to situational environmental data of said data capturing device during a capture of said subject data.

9. A method for categorizing files of non-textual data comprising the steps of:
establishing a sequential progression of decision making, including using automated processing techniques to define a dependent arrangement of a plurality of task nodes, each said task node being associated with a class for classifying a data file, at least some of said task nodes including algorithms for determining which alternative next task node is to be selected in said sequential progression of decision making, said task nodes including multi-algorithmic task nodes having a plurality of alternative said algorithms for implementing said determination;
receiving a file of non-textual subject data; and
progressing said file through said sequential progression of decision making, including selecting from among said alternative algorithms at said multi-algorithmic decision nodes at least partially based on prior determinations at previously encountered task nodes in said sequential progression.

10. The method of claim 9 wherein said step of establishing includes a learning procedure in which content-based data is extracted from each of a plurality of training images and meta-data is identified for each said training image.

11. The method of claim 10 further comprising a step of generating a plurality of learning classes that are descriptive of said training images, including using an association pattern technique, said step of generating including applying content-based analysis for said content-based data and meta-data analysis for said meta-data.

12. The method of claim 9 further comprising a step of dynamically modifying said sequential progression of decision making, including monitoring said determinations at each of said decision nodes and adjusting for detected patterns in said determinations.

13. The method of claim 9 further comprising a step of assigning a semantic description to said file of non-textual subject data for one of organizing said file and matching a query during a search for said file.

14. A method for identifying a class for a data file at a classification node comprising the steps of:
subjecting an image data file to a transformation function to generate transformed image data, said step of subjecting including transforming at least one of content-based data and meta-data, said content-based data corresponding to image data of said file and said meta-data corresponding to situationally surrounding conditions of a recording device during a capture of said image data file;
performing feature analysis on said transformed image data to derive feature data characteristic of said file; and
applying an algorithmic routine utilizing said feature data to generate a class identifiable with said file.

15. The method of claim 14 wherein said step of applying includes selecting said algorithmic routine from a plurality of algorithmic routines.

16. The method of claim 14 further comprising a step of defining said algorithmic routine for generating said class based on a training procedure by subjecting a plurality of training image data files having characteristics attributable with said class.

17. The method of claim 14 wherein said step of applying includes a selection of said algorithmic routine at least partially based on a determination of a previous classification task.

18. The method of claim 14 wherein said step of performing said feature analysis includes applying statistical analysis on said transformed image data.
